(19) United States
(12) Patent Application Publication
(10) Pub. No.: US 2024/0185126 A1
(43) Pub. Date: Jun. 6, 2024

(54) SYSTEM AND NON-TRANSITORY COMPUTER READABLE MEDIUM STORING PROGRAM

(71) Applicant: FUJIFILM Business Innovation Corp., Tokyo (JP)

(72) Inventor: Tomoyuki MITSUHASHI, Kanagawa (JP)

(73) Assignee: FUJIFILM Business Innovation Corp, Tokyo (JP)

(21) Appl. No.: 18/324,119

(22) Filed: May 25, 2023

(30) Foreign Application Priority Data
Dec. 2, 2022 (JP) 2022-193577

(51) Int. Cl. G06N 20/00

(52) U.S. Cl. CPC G06N 20/00

(57) ABSTRACT

A system includes: one or plural processors configured to: acquire information related to a trouble and information on maintenance executed for the trouble; generate a learning model to which the information related to the trouble is input and from which the information on the maintenance is output; re-train the learning model based on information related to a new trouble and information on the maintenance output for the new trouble; and perform weighting on the information on the maintenance in a case where the learning model is re-trained.

### CROSS-REFERENCE TO RELATED APPLICATIONS

This application is based on and claims priority under 35 USC 119 from Japanese Patent Application No. 2022-193577 filed Dec. 2, 2022.

### BACKGROUND

### (i) Technical Field

The present invention relates to a system and a non-transitory computer readable medium storing a program.

### (ii) Related Art

In JP5808605B, there is described an abnormality detection and diagnosis method that detects an abnormality or a sign of the abnormality of a plant or equipment from sensor data or operation data, associates the sign of the abnormality or the abnormality with a past countermeasure by using information on a maintenance history for a similar abnormality in the past, instructs a countermeasure plan based on a result of the associating, and adjusts a sensitivity of abnormality detection based on an accuracy rate of the countermeasure plan.

In JP2021-99702A, there is described a learning apparatus capable of accurately correct-answering, in a case where a user re-trains a model trained by using normal data by using caution data specifically to require the model to output a correct answer, the caution data while maintaining generalizability, by increasing a weight of the caution data and re-training the model.

### SUMMARY

For example, there is a system that is trained, in a case where a trouble occurs, by associating information related to the trouble with parts replaced by an engineer in the trouble as parts necessary for resolving the trouble, and presents the replacement parts in a case where the information related to the trouble is input. Meanwhile, in a case where a plurality of parts are replaced, it is difficult to specify a part that is really necessary among the replaced parts, and in a case where the system is updated by re-learning, treating incorrect parts as correct answer data may cause a noise to be continuously amplified. For example, in maintenance other than replacement of parts, in a case where unnecessary maintenance is treated as correct answer data, the noise is continuously amplified in the same manner.

Aspects of non-limiting embodiments of the present disclosure relate to a system and a non-transitory computer readable medium storing a program that lower a presentation rate of information on maintenance of an incorrect answer, as compared with a case where all of the executed maintenance are uniformly re-learned as correct answer data.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided a system including: one or a plurality of processors configured to: acquire information related to a trouble and information on maintenance executed for the trouble; generate a learning model to which the information related to the trouble is input and from which the information on the maintenance is output; re-train the learning model based on information related to a new trouble and information on the maintenance output for the new trouble; and perform weighting on the information on the maintenance in a case where the learning model is re-trained.

### BRIEF DESCRIPTION OF THE DRAWINGS

Exemplary embodiment(s) of the present invention will be described in detail based on the following figures, wherein:

FIG. 1 is a diagram illustrating a configuration of a system according to the present exemplary embodiment;

FIG. 2 is a diagram illustrating a hardware configuration example of a computer used as a management server and an engineer terminal;

FIG. 3 is a diagram illustrating a functional configuration of the management server according to the present exemplary embodiment;

FIG. 4 is a diagram illustrating a functional configuration of the engineer terminal according to the present exemplary embodiment;

FIG. 5 is a flowchart illustrating a flow of processes at a time of troubleshooting according to the present exemplary embodiment;

FIG. 6 is a flowchart illustrating a flow of generation of a learning model according to the present exemplary embodiment;

FIG. 7 is a diagram illustrating an example of a deep learning model;

FIG. 8 is a diagram illustrating an example of a screen of displaying information on maintenance;

FIGS. 9A and 9B are diagrams illustrating an example of weighting according to the present exemplary embodiment, FIG. 9A is a diagram illustrating an example of assigning a smaller weight to a replacement part as a ratio of being presented for a past trouble of the replacement part is higher, and FIG. 9B is a diagram illustrating an example of assigning a smaller weight to the presented replacement part as a ratio of a case a trouble is resolved by replacing a replacement part that is different from the replacement part presented for the past trouble is higher;

FIG. 10 is a diagram for describing a learning model that outputs replacement parts by inputting information related to a trouble; and

FIG. 11 is a diagram illustrating an example of a learning period of the learning model.

### DETAILED DESCRIPTION

Hereinafter, the present exemplary embodiments will be described in detail with reference to drawings.

### Learning Model

First, a learning model according to the present exemplary embodiment will be described. The learning model according to the present exemplary embodiment outputs information on maintenance by an input of information related to a trouble.

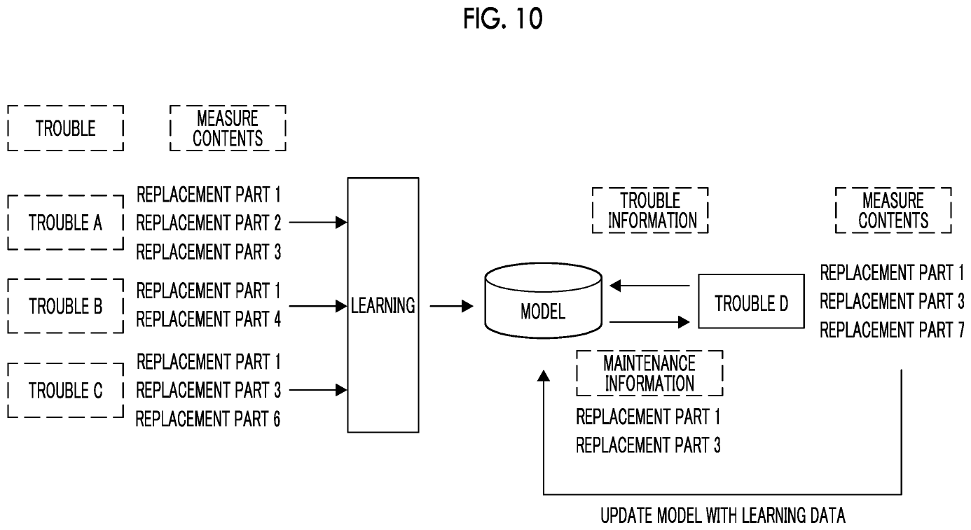

FIG. 10 is a diagram for describing a learning model that outputs replacement parts by an input of information related to a trouble.

In an example illustrated in FIG. 10, the learning model is trained by associating information related to a trouble A with a replacement part 1, a replacement part 2, and a replacement part 3, associating information related to a trouble B with the replacement part 1 and a replacement part 4, and associating information related to a trouble C with the replacement part 1, the replacement part 3, and a replacement part 6. By being trained by associating the information related to the trouble with the replaced parts in this manner, a learning model that outputs replacement parts by an input of the information related to the trouble is generated.

In operating the learning model, it is necessary to periodically execute re-learning and update the learning model so as to reflect information on the latest trouble and replacement parts.

In the example illustrated in FIG. 10, information related to a trouble D, which newly occurs, is input, and the replacement part 1 and the replacement part 3 are presented by the learning model. An engineer dealing with the trouble D replaces the replacement part 1 and the replacement part 3 in response to the presentation of the replacement parts by the learning model, and further replaces a replacement part 7 in the example illustrated in FIG. 10. Here, the replacement part 7 is not presented from the learning model, and is replaced by determination of the engineer.

The learning model is updated by re-learning in which information on a trouble that newly occurs is associated with information on maintenance executed for the trouble. In the example illustrated in FIG. 10, the learning model is updated by being trained by associating the information related to the trouble D with the part replaced by the engineer for the trouble D.

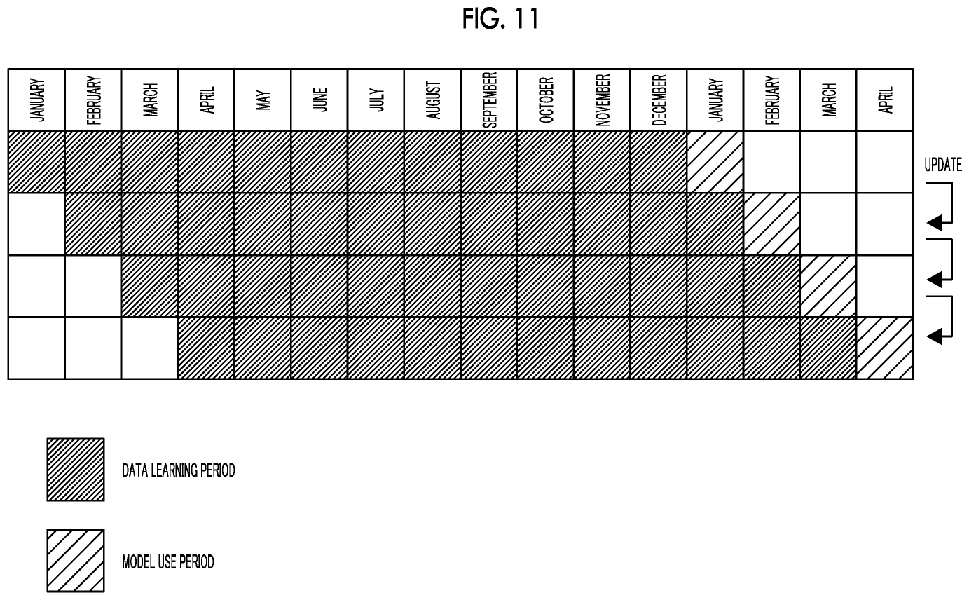

The update of the learning model may have a configuration in which a learning period of the learning model is defined such that old learning data is not reflected. The learning period of the learning model will be described with reference to FIG. 11. FIG. 11 is a diagram illustrating an example of a learning period of a learning model.

In an example illustrated in FIG. 11, the learning model is updated every month, and the learning model trained by using data for the most recent one year is used. More specifically, a learning model used in January is a learning model generated by being trained by associating troubles that occurred in one year from January one year ago to the most recent December with measure contents executed for each trouble. In a case where the learning model is updated and operated every month, a learning model used in April is a learning model including a result of measures of the engineer based on information on replacement parts presented by a learning model used from January to March.

Here, in the same manner as in the case where the trouble D is handled in the example illustrated in FIG. 10, in a case where a trouble is resolved by replacing parts other than presented replacement parts, it is difficult to specify a part that is really necessary among the replaced parts. Therefore, in a case where the learning model is updated, it is necessary to treat all the replaced parts as correct answer data. Thereby, an incorrect answer noise may occur due to incorrect replacement parts being treated as correct answer data, and the incorrect answer noise may be continued to be amplified every time the learning model is updated.

Amplification of an incorrect answer noise will be described by taking as an example a case where a learning model is created by being trained with data for the most recent one year and the model is updated every month as illustrated in FIG. 11. For example, it is assumed that the trouble D illustrated in FIG. 10 occurs in a learning model to be used in January. In this case, a learning model to be used in February is a learning model trained with the replacement part 1, the replacement part 3, and the replacement part 7 as correct answer data for the trouble D.

Here, in a case where the replacement part 1 and the replacement part 3 do not contribute to the resolution of the trouble D at all, the learning model to be used in February is trained with incorrect answer parts by associating the trouble D with the replacement part 1 and the replacement part 3, and includes an incorrect answer noise. Further, a learning model to be used in March is a model trained with the incorrect answer noise included in the models used in January and February as correct answer data, and a learning model to be used in April a model trained with the incorrect answer noise included in the models used from January to March as correct answer data.

In this manner, the incorrect answer noise is treated as correct answer data in a case where the learning model includes the incorrect answer noise, so the incorrect answer noise is amplified every time the learning model is updated, and there is a high risk in which the incorrect answer noise will be reflected in the next month's model.

Therefore, in the present exemplary embodiment, weighting is performed on the correct answer data in a case where the learning model is updated.

### Configuration of System

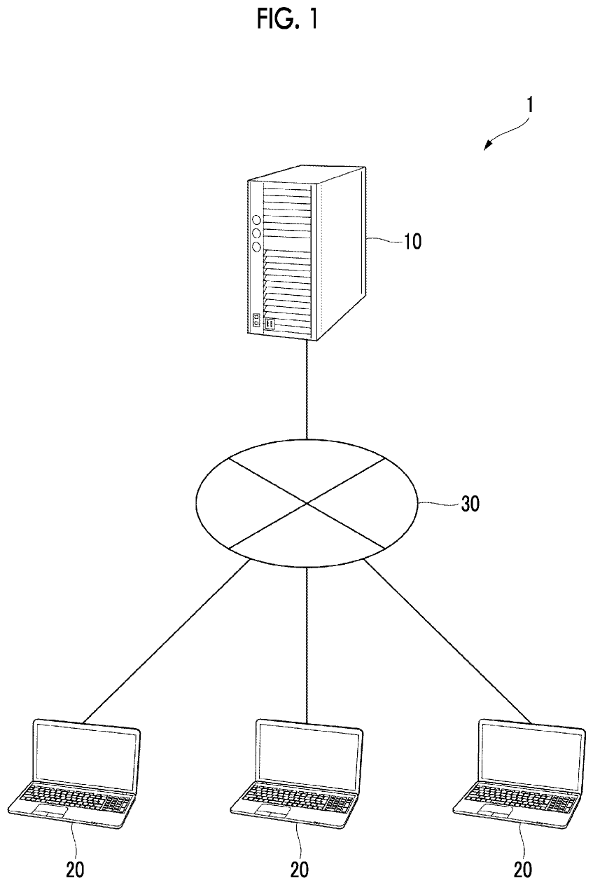

FIG. 1 is a diagram illustrating a configuration of a system 1 according to the present exemplary embodiment.

The system 1 according to the present exemplary embodiment includes a management server 10 and an engineer terminal 20. The management server 10 and the engineer terminal 20 are connected to each other via a network 30.

The management server 10 is a server that manages history information and the like related to information related to a trouble and information on maintenance executed for the trouble. The information related to the trouble is, for example, information related to an abnormality of equipment, and the information on the maintenance is information indicating what kind of maintenance is executed for the trouble. For example, in a case where parts are replaced as measures to a failure of a printer, information on failure contents of the printer is information related to a trouble, and information on the replaced parts is information on maintenance.

In addition, the management server 10 generates a learning model which is trained by associating information related to a trouble with information on maintenance executed for the trouble, and to which the information related to the trouble is input and from which the information on the maintenance is output. In a case where the generated learning model is re-trained based on information related to a new trouble and information on maintenance output for the new trouble, the information on the maintenance is weighted.

The management server 10 is realized by, for example, a computer. The management server 10 may be configured by a single computer, or may be realized by a distribution process by a plurality of computers.

The engineer terminal 20 is an information processing apparatus to which an engineer inputs information related to a trouble and from which information on maintenance is output to the engineer. The engineer terminal 20 connects to the management server 10 via the network 30.

The engineer terminal 20 is realized by, for example, a computer, a tablet-type information terminal, or another information processing apparatus.

The network 30 is an information communication network that is responsible for communication between the management server 10 and the engineer terminal 20. A type of the network 30 is not particularly limited as long as data can be transmitted and received, and may be, for example, the Internet, a local area network (LAN), a wide area network (WAN), or the like. A communication line used for data communication may be wired or wireless. In addition, each apparatus may be configured to be connected via a plurality of networks or communication lines.

### Hardware Configuration of Computer

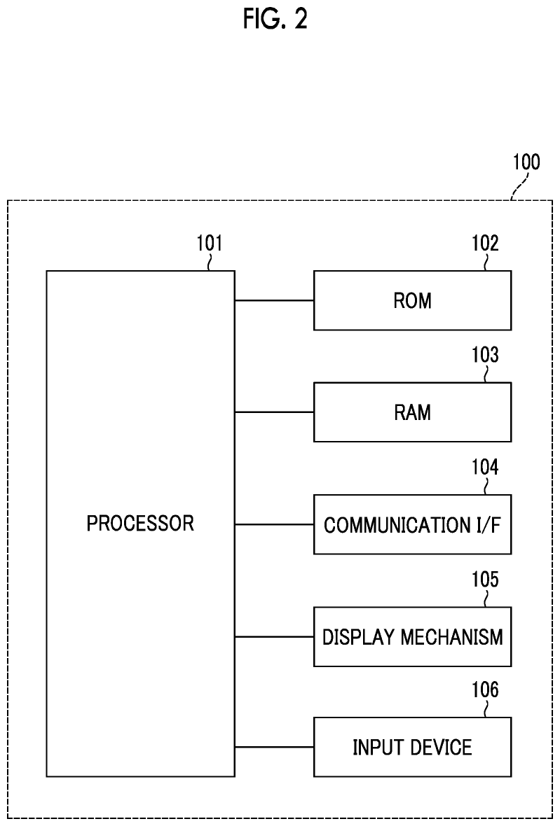

FIG. 2 is a diagram illustrating a hardware configuration example of a computer 100 used as the management server 10 and the engineer terminal 20. The computer 100 includes a processor 101, a read only memory (ROM) 102, and a random access memory (RAM) 103. The processor 101 is, for example, a central processing unit (CPU), and uses the RAM 103 as a work area to execute a program read from the ROM 102. Further, the computer 100 includes a communication interface 104 for connecting to a network and a display mechanism 105 for performing a display output on a display. In addition, the computer 100 includes an input device 106 with which an input operation is performed by an operator of the computer 100. The configuration of the computer 100 illustrated in FIG. 2 is only an example, and a computer used in the present exemplary embodiment is not limited to the configuration example in FIG. 2.

The various processes to be executed in the present exemplary embodiment are executed by one or a plurality of processors.

### Functional Configuration of Management Server

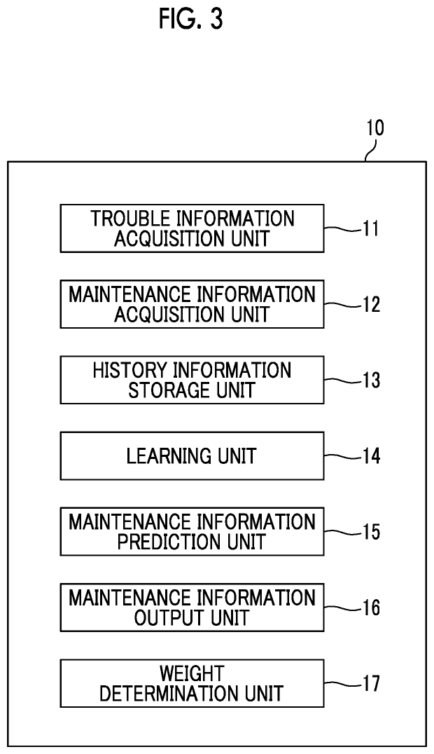

Next, a functional configuration of the management server 10 will be described. FIG. 3 is a diagram illustrating a functional configuration of the management server 10 according to the present exemplary embodiment.

As illustrated in FIG. 3, the management server 10 includes a trouble information acquisition unit 11 that acquires information related to a trouble that occurs, a maintenance information acquisition unit 12 that acquires information on maintenance executed for the trouble, and a history information storage unit 13 that stores a history of the acquired information related to the trouble and the information on the maintenance. In addition, the management server 10 includes a learning unit 14 that generates a learning model which is trained by associating information related to a trouble with information on maintenance executed for the trouble, and to which the information related to the trouble is input and from which the information on the maintenance is output. Further, the management server 10 includes a maintenance information prediction unit 15 that predicts the information on the maintenance corresponding to the acquired information related to the trouble, a maintenance information output unit 16 that outputs the predicted information on the maintenance, and a weight determination unit 17 that determines a weight to be assigned to the information on the maintenance output at a time of re-training of the learning model.

In a case where the management server 10 illustrated in FIG. 3 is realized by the computer 100 illustrated in FIG. 2, each function of the trouble information acquisition unit 11, the maintenance information acquisition unit 12, and the maintenance information output unit 16 is realized by, for example, the communication interface 104. The history information storage unit 13 is realized by, for example, the ROM 102. Each function of the learning unit 14, the maintenance information prediction unit 15, and the weight determination unit 17 is realized, for example, by the processor 101 executing a program.

### Functional Configuration of Engineer Terminal

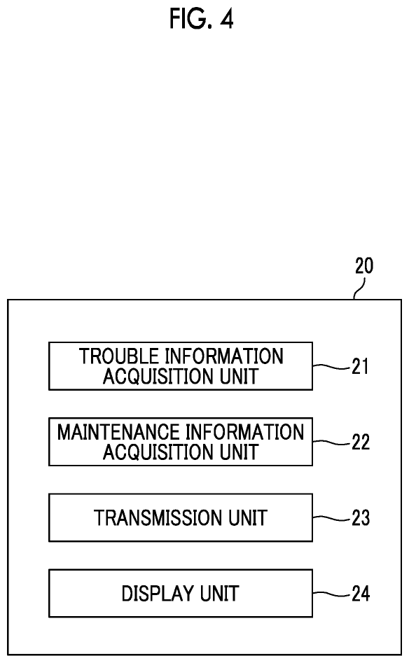

FIG. 4 is a diagram illustrating a functional configuration of the engineer terminal 20 according to the present exemplary embodiment. As illustrated in FIG. 4, the engineer terminal 20 includes a trouble information acquisition unit 21 that acquires information related to a trouble that occurs, a maintenance information acquisition unit 22 that acquires information on maintenance executed for the trouble, a transmission unit 23 that transmits the acquired information related to the trouble and the information on the maintenance to the management server 10, and a display unit 24 that displays the information on the maintenance acquired from the learning model.

In a case where the engineer terminal 20 illustrated in FIG. 4 is realized by the computer 100 illustrated in FIG. 2, the trouble information acquisition unit 21, the maintenance information acquisition unit 22, and the transmission unit 23 are realized by, for example, the communication interface 104. The display unit 24 is realized by, for example, the display mechanism 105.

### Process at Troubleshooting

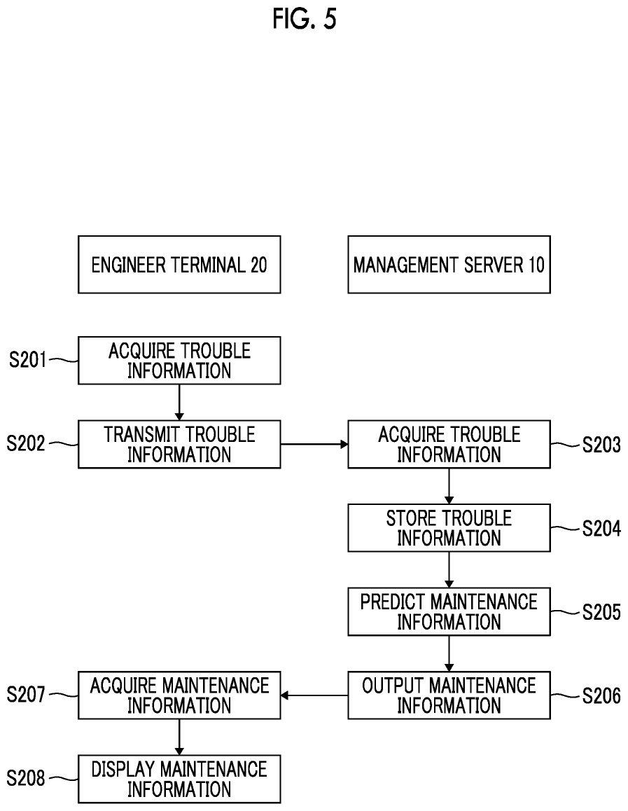

Next, a flow of processes at a time of troubleshooting will be described with reference to FIG. 5. FIG. 5 is a flowchart illustrating a processing flow at the time of troubleshooting according to the present exemplary embodiment.

In FIG. 5, first, in a case where a trouble occurs, the trouble information acquisition unit 21 of the engineer terminal 20 acquires information related to the trouble that occurs (step S201). The trouble information acquisition unit 21 acquires the information related to the trouble input by an engineer from an input screen realized by, for example, the input device 106. The information related to the trouble acquired by the trouble information acquisition unit 21 is transmitted to the management server 10 by the transmission unit 23 of the engineer terminal 20 (step S202), and is acquired by the trouble information acquisition unit 11 of the management server 10 (step S203). The information related to the trouble acquired by the trouble information acquisition unit 11 is stored in the history information storage unit 13 of the management server 10 (step S204).

Subsequently, the maintenance information prediction unit 15 of the management server 10 predicts information on maintenance based on a learning model (step S205). The maintenance information output unit 16 of the management server 10 outputs the information on the maintenance predicted by the maintenance information prediction unit 15 (step S206). Details of generation of the learning model used in step S205 and a process at the time of learning will be described below.

Subsequently, the maintenance information acquisition unit 22 of the engineer terminal 20 acquires the information on the maintenance output by the learning model (step S207), and the information on the maintenance acquired by the maintenance information acquisition unit 22 is displayed on the display unit 24 of the engineer terminal 20 (step S208). Details of a display format of the information on the maintenance will be described below.

The engineer deals with the trouble based on the information on the maintenance displayed on the display unit 24 of the engineer terminal 20.

### Generation of Learning Model

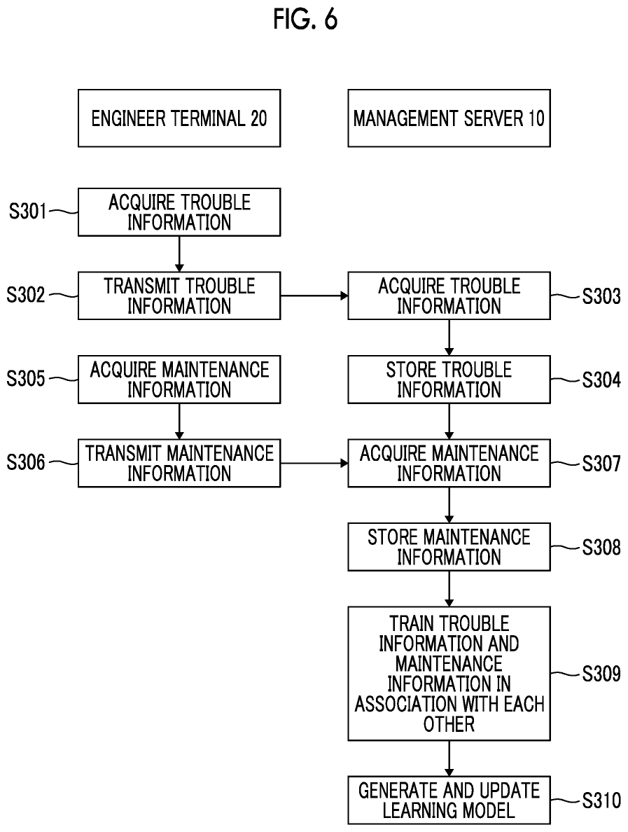

Next, generation of a learning model will be described with reference to FIG. 6. FIG. 6 is a flowchart illustrating a flow of generation of a learning model according to the present exemplary embodiment.

The learning unit 14 generates a learning model that is trained by associating information related to a trouble stored in the history information storage unit 13 with information on maintenance executed for the trouble, and predicts and presents the information on the maintenance from the information related to the trouble.

In FIG. 6, first, the trouble information acquisition unit 21 of the engineer terminal 20 acquires information related to a trouble that occurs (step S301). The information related to the trouble acquired by the trouble information acquisition unit 21 is transmitted to the management server 10 by the transmission unit 23 of the engineer terminal 20 (step S302), and is acquired by the trouble information acquisition unit 11 of the management server 10 (step S303). The information related to the trouble acquired by the trouble information acquisition unit 11 is stored in the history information storage unit 13 of the management server 10 (step S304).

Subsequently, the maintenance information acquisition unit 22 of the engineer terminal 20 acquires information on maintenance executed by an engineer for the trouble that occurs (step S305). The maintenance information acquisition unit 22 acquires the information on the maintenance input by the engineer from, for example, an input screen realized by the input device 106. The information on the maintenance acquired by the maintenance information acquisition unit 22 is transmitted to the management server 10 by the transmission unit 23 of the engineer terminal 20 (step S306), and is acquired by the maintenance information acquisition unit 12 of the management server 10 (step S307). The information on the maintenance acquired by the maintenance information acquisition unit 12 is stored in the history information storage unit 13 of the management server 10 (step S308).

Subsequently, the learning unit 14 of the management server 10 learns the information related to the trouble with the information on the maintenance executed for the trouble stored in the history information storage unit 13 in association with each other (step S309). The learning unit 14 generates and updates a learning model to which information related to a trouble is input and from which information on maintenance is output (step S310). Details of updating the learning model will be described below.

### Process of Learning Unit

Next, an example of a process in steps S309 and S310 in FIG. 6 by the learning unit 14 will be described.

The learning unit 14 generates a learning model which is trained by associating information related to a trouble with information on maintenance executed for the trouble, and to which the information related to the trouble is input and from which the information on the maintenance is output. The function of the learning unit 14 is realized, for example, by the processor 101 of the computer 100 executing a machine learning program.

The machine learning program is a program for machine learning of a relationship in which information related to a trouble is input and information on maintenance is output.

In the machine learning program, the information related to the trouble and the information on the maintenance executed for the trouble are given as teacher data, for example, a variable in each layer constituting a deep learning model is adjusted based on the teacher data. In a case where the information related to the trouble is given as an input, the learning is advanced such that the information on the maintenance for the trouble is output.

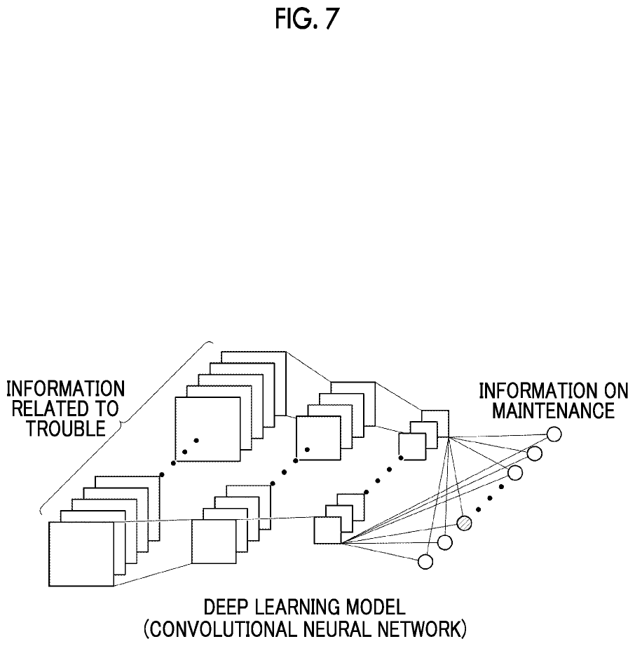

FIG. 7 is a diagram illustrating an example of a deep learning model. In FIG. 7, a convolutional neural network (CNN) is illustrated as the example of the deep learning model.

The convolutional neural network is configured with an input layer, an output layer, and many hidden layers between the input layer and the output layer. A convolutional layer, which is a typical example of the hidden layer, extracts features of information related to a trouble, and then a pooling layer extracts an average or the maximum value of the extracted features. The convolutional neural network has a multi-layer structure in which a unit structure configured with the convolutional layer and the pooling layer is connected in multiple stages. These operations are repeated, and learning is advanced by identifying different features for each layer.

In the learning model, for example, a probability that each of a plurality of pieces of information on maintenance held as candidates is correct answers is calculated. Among the pieces of information, the information having a threshold value equal to or more than a predetermined threshold value is output, or a predetermined number of pieces of information having high probabilities are output from a top.

In the example illustrated in FIG. 7, one or a plurality of pieces of information on maintenance among pieces of information on the maintenance held as candidates are output in response to the input of the information related to the trouble.

### Display Format

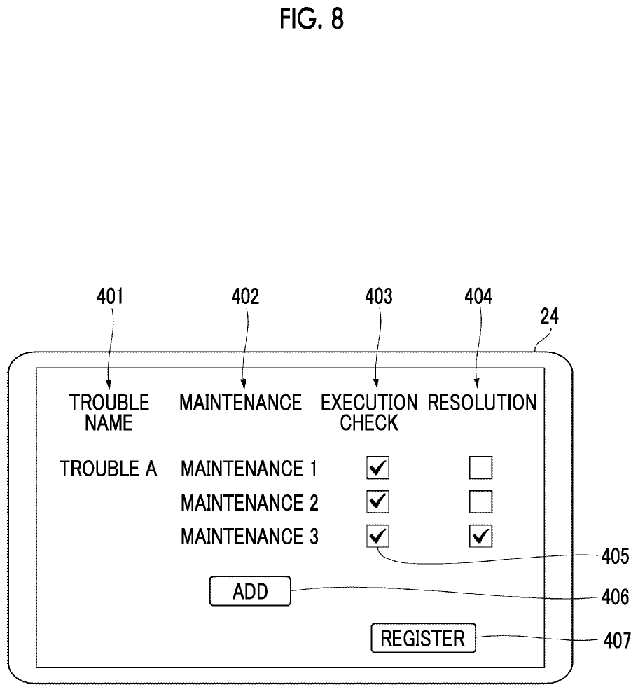

Next, a display format in step S208 in FIG. 5 will be described with reference to FIG. 8. FIG. 8 is a diagram illustrating an example of a screen of displaying information on maintenance.

In a case where the information on the maintenance is to be displayed, the display unit 24 of the engineer terminal 20 displays the information on the maintenance. Further, the display unit 24 may display, together with the information on the maintenance, a screen for accepting an input of an engineer as to whether the presented maintenance is executed or whether the trouble is resolved by executing the presented maintenance.

As illustrated in FIG. 8, the display unit 24 of the engineer terminal 20 displays a trouble name 401 and a maintenance content 402. In addition, the display unit 24 displays an execution check 403 and resolution 404, and accepts an input of the engineer. Further, the display unit 24 displays an addition button 406 and a registration button 407.

In FIG. 8, the display unit 24 of the engineer terminal 20 displays a trouble A in the trouble name 401. In addition, the display unit 24 displays maintenance 1, maintenance 2, and maintenance 3 on the maintenance content 402 for the trouble A. Further, the display unit 24 displays check boxes 405 in the execution check 403 and the resolution 404, and accepts an input as to whether each maintenance is executed by the engineer and whether the trouble is resolved by executing the presented maintenance.

The engineer performs an input in a format in which the check box 405 is checked. In the example illustrated in FIG. 8, the engineer executes all maintenance of the maintenance 1, the maintenance 2, and the maintenance 3. Further, it is indicated that the trouble A is not resolved by the execution of the maintenance 1 and the maintenance 2, and the trouble A is resolved by the execution of the maintenance 3.

In a case where the trouble is not resolved by executing the presented maintenance and the engineer executes other maintenance at determination of the engineer, the engineer can add information on the executed maintenance from the addition button 406. The input is completed by the engineer pressing the registration button 407.

### Update of Learning Model

In an operation of a learning model, it is necessary to periodically execute re-learning and update the learning model to reflect the latest troubles and information on replacement parts. In a case of updating the learning model, the management server 10 acquires information on the new trouble and information on maintenance executed for the trouble, and updates the learning model by causing the learning model to be re-trained.

In a case where a new trouble occurs, the engineer inputs information related to the trouble into the trouble information acquisition unit 21 of the engineer terminal 20 as illustrated in FIG. 7, and deals with the trouble based on information on maintenance displayed on the display unit 24 of the engineer terminal 20. The engineer inputs the information on the executed maintenance to the maintenance information acquisition unit 22 of the engineer terminal 20.

In the present exemplary embodiment, at a time of updating a learning model, the management server 10 treats all information on maintenance executed by an engineer as correct answer data, and performs re-learning. Meanwhile, for example, in a case where a trouble is resolved by executing maintenance other than the information on the maintenance presented by the learning model, the information on the maintenance presented by the learning model may be an incorrect answer noise.

Therefore, in the present exemplary embodiment, the management server 10 weights correct answer data at the time of updating the learning model, thereby suppressing amplification of the incorrect answer noise in the learning model. The weighting is performed on a correct answer label associated with the information on the maintenance. In a case where re-learning is performed with the correct answer data, the correct answer label is set to 1 in a case where the weighting is not performed, and a value of the correct answer label is lowered to perform re-learning in a case where the weighting is performed.

In the learning model according to the present exemplary embodiment, for example, a probability that information on maintenance held as a candidate is a correct answer is calculated. By updating the learning model, a variable in each layer constituting a deep learning model is changed, and the probability which is the correct answer is changed. By weighting the correct answer data in the re-learning, a probability that information on maintenance to which a small weight is assigned is a correct answer is lowered, and the information on the maintenance is less likely to be presented. Thereby, the amplification of the incorrect answer noise of the learning model can be suppressed.

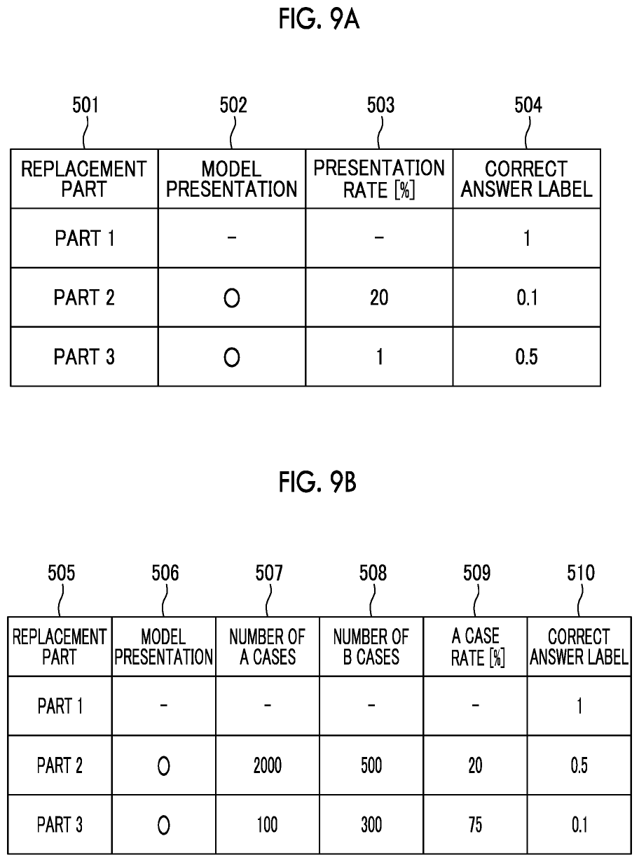

An example of weighting according to the present exemplary embodiment will be described with reference to FIGS. 9A and 9B. FIGS. 9A and 9B are diagrams illustrating the example of weighting according to the present exemplary embodiment. FIGS. 9A and 9B illustrate an example in a case where a replacement part is presented as information on maintenance for a trouble.

### Example 1 of Weighting at Re-Learning

In Example 1 of weighting at a time of re-learning, based on a fact that information on maintenance is presented for a past trouble, the weight determination unit 17 of the management server 10 weights the presented information on the maintenance.

For example, the weight determination unit 17 assigns a smaller weight to the presented information on the maintenance as a ratio of the information on the maintenance presented for the past trouble is increased.

A learning model analyzes contents of the trouble and predicts and presents the corresponding information on the maintenance, and information on maintenance having a high ratio of being presented in the past and a high execution rate may be presented even in a case of an incorrect answer. Therefore, in a case where the information on the maintenance having a high ratio of being presented for the past troubles is presented, there is a high possibility that the information on the maintenance is presented regardless of what kind of trouble it is, so a small weight is assigned.

On the other hand, in the case where information on maintenance having with a low ratio of being presented for the past trouble is presented, there is a high possibility that the information is a correct answer presented for a rare trouble, so that the information on the maintenance is designed to be weighted higher than the information on the maintenance having a high presentation rate.

The format of weighting is not limited to this example. For example, a weight may be assigned regardless of the ratio, such as assigning a small weight to the past trouble in a case where the information on the maintenance is presented a predetermined number of times or more.

An example of weighting will be described with reference to FIG. 9A. FIG. 9A is a diagram illustrating an example in which a smaller weight is assigned to a replacement part as a ratio of being presented for a past trouble of the replacement part is increased.

In an example illustrated in FIG. 9A, a part presented by a learning model at a time of occurrence of a trouble is weighted for a correct answer label of the replacement part based on a presentation rate of being presented for past trouble, regardless of whether or not the part is a correct answer part for the trouble.

FIG. 9A illustrates a replacement part 501, model presentation 502, a presentation rate 503, and a correct answer label 504. The replacement part 501 indicates a part that is replaced as a measure to a trouble that occurs. The model presentation 502 indicates whether or not the replacement part is presented by a model. The presentation rate 503 indicates a presentation rate of being presented for a past trouble in a case where the replacement part 501 is presented by the model. The correct answer label 504 indicates a weight assigned to a correct answer label associated with the replacement part 501 in a case where the learning model is trained by using the replacement part 501 as correct answer data.

In the example illustrated in FIG. 9A, the weight determination unit 17 of the management server 10 weights the presented replacement part 501 to 0.8 in a case where the presentation rate 503 of the replacement part 501 for the past trouble is less than 1%, weights the presented replacement part 501 to 0.5 in a case where the presentation rate 503 of the replacement part 501 for the past trouble is equal to or more than 1% and less than 10%, and weights the presented replacement part 501 to 0.1 in a case where the presentation rate 503 of the replacement part 501 for the past trouble is equal to or more than 10%, respectively. Further, since the replacement part 501 not presented by the model is considered to be a correct answer part replaced at determination of an engineer, no weighting is performed and the correct answer label 504 is 1.

For example, since a part 1 is not presented as information on maintenance by the model, no weighting is performed and the correct answer label 504 is 1. Since a part 2 is presented by the model and the presentation rate 503 for the past trouble is 20%, the correct answer label 504 is weighted to 0.1. Since a part 3 is presented by the model and the presentation rate 503 for the past trouble is 1%, the correct answer label 504 is weighted to 0.5.

The weighting method illustrated in FIG. 9A is an example of weighting, and is not limited to this format.

### Example 2 of Weighting at Re-learning

In Example 2 of weighting at a time of re-learning, based on a result of execution based on information on maintenance presented for a past trouble, the weight determination unit 17 of the management server 10 weights the presented information on the maintenance. There are two cases as the result of the execution based on the information on the maintenance presented for the past trouble. One is a case where the trouble is resolved by the presented information on the maintenance, and the other is a case where the trouble is not resolved by the presented information on the maintenance and the trouble is resolved by other maintenance executed by determination of an engineer. For example, the weight determination unit 17 of the management server 10 weights information on maintenance presented according to a ratio between these two cases.

For example, as a ratio of a case where the trouble is resolved by executing maintenance different from the information on the maintenance presented for the past trouble is higher, the weight determination unit 17 assigns a smaller weight to the presented information on the maintenance.

In the case where the trouble is resolved by executing maintenance different from the presented information on the maintenance, it cannot be determined that the presented information on the maintenance is incorrect answer information. Meanwhile, in a case where the trouble is not resolved by the presented information on the maintenance, there is a low possibility that the presented information on the maintenance is correct answer information. Therefore, the higher the ratio of cases where the trouble is resolved by executing the maintenance not presented in this manner, the smaller weight is assigned to the presented information on the maintenance.

An example of weighting will be described with reference to FIG. 9B. FIG. 9B is a diagram illustrating an example of assigning a smaller weight to a presented replacement part as a ratio of a case where a trouble is resolved by replacing a replacement part different from a replacement part presented for a past trouble is higher.

In FIG. 9B, a case where a trouble is resolved by information on maintenance presented for a past trouble is an A case, and a case in which the trouble is not resolved by the information on the presented for the past trouble and the trouble is resolved by other maintenance executed by determination of an engineer is a B case. For example, “the number of A cases of part 1 is 100” means that there are 100 cases in which the learning model presents the replacement part 1 for the past trouble and the trouble is resolved by replacement of the replacement part 1.

FIG. 9B illustrates a replacement part 505, a model presentation 506, a number of A cases 507, a number of B cases 508, an A case rate 509, and a correct answer label 510. The replacement part 505 indicates a part that is replaced as a measure to a trouble that occurs. The model presentation 506 indicates whether or not the replacement part is presented by a model. The number of A cases 507 indicates the number of A cases in the past trouble in a case where the replacement part 505 is presented by the model. The number of B cases 508 indicates the number of B cases in the past trouble in a case where the replacement part 505 is presented by the model. The A case rate 509 indicates an A case rate in the past trouble in a case where the replacement part 505 is presented by the model. The correct answer label 510 indicates a weight assigned to a correct answer label associated with the replacement part 505 in a case where the learning model is trained by using the replacement part 501 as correct answer data.

In the example illustrated in FIG. 9B, the weight determination unit 17 of the management server 10 weights the replacement part 505 based on a ratio of the A case and the B case presented for all the past troubles. The weight determination unit 17 sets the weight to 0.8 in a case where the A case rate 509 is less than 10%, sets the weight to 0.5 in a case where the A case rate 509 is equal to or more than 10% and less than 50%, and sets the weight to 0.1 in a case where the A case rate 509 is equal to or more than 50%, respectively. Further, since the replacement part 505 not presented by the model is considered to be a correct answer part replaced at determination of an engineer, no weighting is performed and the correct answer label 510 is 1.

For example, since the part 1 is not presented as information on maintenance by the model, no weighting is performed and the correct answer label 510 is 1. Since the part 2 is presented by the model and the A case rate 509 is 20%, the correct answer label 510 is weighted to 0.5. Since the part 3 is presented by the model and the A case rate 509 is 75%, the correct answer label 510 is weighted to 0.5.

The weighting method illustrated in FIG. 9B is an example of weighting, and is not limited to this format.

Although the present exemplary embodiments are described above, a technical scope of the exemplary embodiments of the present invention is not limited to the scope described in the exemplary embodiments described above. Various modifications or improvements are added to the exemplary embodiments described above within the technical scope of the exemplary embodiments of the present invention.

For example, although the above description is made by using an example in which an engineer handles a trouble, the exemplary embodiment is not limited to this format. A form may be adopted in which a measure instruction is given to a user who inputs trouble contents of a trouble that occurs at home or the like.

### Supplementary Note

(((1)))

A system comprising:
one or a plurality of processors configured to:
   acquire information related to a trouble and information on maintenance executed for the trouble;
   generate a learning model to which the information related to the trouble is input and from which the information on the maintenance is output;
   re-train the learning model based on information related to a new trouble and information on the maintenance output for the new trouble; and
   perform weighting on the information on the maintenance in a case where the learning model is re-trained.
      (((2)))

The system according to (((1))), wherein the one or plurality of processors are configured to:
perform weighting on the information on the maintenance based on a fact that information on the maintenance is presented for a past trouble.
   (((3)))

The system according to (((2))), wherein the one or plurality of processors are configured to:
assign a smaller weight to the information on the maintenance as a ratio of the information on the maintenance presented for the past trouble is increased.
   (((4)))

The system according to (((1))), wherein the one or plurality of processors are configured to:
perform weighting on the information on the maintenance based on a result of execution based on information on the maintenance presented for a past trouble.
   (((5)))

The system according to (((4))), wherein the one or plurality of processors are configured to:
perform weighting on the presented information on the maintenance according to a status of a case where the trouble is resolved by the maintenance executed based on the information on the maintenance presented for the past trouble, and a case where the trouble is resolved by executing maintenance different from the presented information of the maintenance.
   (((6)))

The system according to (((5))), wherein the one or plurality of processors are configured to:
assign a smaller weight to the presented information on the maintenance as a ratio of the case where the trouble is resolved by executing the maintenance different from the information on the maintenance presented for the past trouble is higher.
   (((7)))

The system according to any one of (((1))) to (((6)) wherein the information related to the trouble is information related to an abnormality of equipment, and the information on the maintenance is information on a part to be replaced.

(((8)))

A non-transitory computer readable medium storing a program causing one or a plurality of processors to realize a function comprising:
acquiring information related to a trouble and information on maintenance executed for the trouble;
generating a learning model to which the information related to the trouble is input and from which the information on the maintenance is output;
re-training the learning model based on information related to a new trouble and information on the maintenance output for the new trouble; and
performing weighting on the information on the maintenance in a case where the learning model is re-trained.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device). In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A system comprising:
one or a plurality of processors configured to:
acquire information related to a trouble and information on maintenance executed for the trouble;
generate a learning model to which the information related to the trouble is input and from which the information on the maintenance is output;
re-train the learning model based on information related to a new trouble and information on the maintenance output for the new trouble; and
perform weighting on the information on the maintenance in a case where the learning model is re-trained.

2. The system according to claim 1, wherein the one or plurality of processors are configured to:
perform weighting on the information on the maintenance based on a fact that information on the maintenance is presented for a past trouble.

3. The system according to claim 2, wherein the one or plurality of processors are configured to:
assign a smaller weight to the information on the maintenance as a ratio of the information on the maintenance presented for the past trouble is increased.

4. The system according to claim 1, wherein the one or plurality of processors are configured to:
perform weighting on the information on the maintenance based on a result of execution based on information on the maintenance presented for a past trouble.

5. The system according to claim 4, wherein the one or plurality of processors are configured to:
perform weighting on the presented information on the maintenance according to a status of a case where the trouble is resolved by the maintenance executed based on the information on the maintenance presented for the past trouble, and a case where the trouble is resolved by executing maintenance different from the presented information of the maintenance.

6. The system according to claim 5, wherein the one or plurality of processors are configured to:
assign a smaller weight to the presented information on the maintenance as a ratio of the case where the trouble is resolved by executing the maintenance different from the information on the maintenance presented for the past trouble is higher.

7. The system according to claim 1,
wherein the information related to the trouble is information related to an abnormality of equipment, and the information on the maintenance is information on a part to be replaced.

8. The system according to claim 2,
wherein the information related to the trouble is information related to an abnormality of equipment, and the information on the maintenance is information on a part to be replaced.

9. The system according to claim 3,
wherein the information related to the trouble is information related to an abnormality of equipment, and the information on the maintenance is information on a part to be replaced.

10. The system according to claim 4,
wherein the information related to the trouble is information related to an abnormality of equipment, and the information on the maintenance is information on a part to be replaced.

11. The system according to claim 5,
wherein the information related to the trouble is information related to an abnormality of equipment, and the information on the maintenance is information on a part to be replaced.

12. The system according to claim 6,
wherein the information related to the trouble is information related to an abnormality of equipment, and the information on the maintenance is information on a part to be replaced.

13. A non-transitory computer readable medium storing a program causing one or a plurality of processors to realize a function comprising:
acquiring information related to a trouble and information on maintenance executed for the trouble;
generating a learning model to which the information related to the trouble is input and from which the information on the maintenance is output;
re-training the learning model based on information related to a new trouble and information on the maintenance output for the new trouble; and
performing weighting on the information on the maintenance in a case where the learning model is re-trained.

14. A system comprising:
means for acquiring information related to a trouble and information on maintenance executed for the trouble;
means for generating a learning model to which the information related to the trouble is input and from which the information on the maintenance is output;
means for re-training the learning model based on information related to a new trouble and information on the maintenance output for the new trouble; and
means for performing weighting on the information on the maintenance in a case where the learning model is re-trained.
